(19) United States
(12) Patent Application Publication
(10) Pub. No.: US 2008/0060205 A1
(43) Pub. Date: Mar. 13, 2008

(54) Magnetic knife holder

(75) Inventors: Hans Jurgen Schmidt, Westwood, NJ (US); Tobi Melissa Schmidt, Westwood, NJ (US)

Correspondence Address: KEUSEY, TUTUNJIAN & BITETTO, P.C., 20 CROSSWAYS PARK NORTH, SUITE 210, WOODBURY, NY, 11797, US

(73) Assignee: SCHMIDT-ALLZWECK, INC.

(21) Appl. No.: 11/698,417

(22) Filed: Jan. 26, 2007

Related U.S. Application Data
(63) Continuation-in-part of application No. 11/519,001, filed on Sep. 12, 2006.

(51) Int. Cl. B26B 27/00

(52) U.S. Cl. 30/298.4; 220/483; 211/70.7

(57) ABSTRACT

A magnetic knife holder including a body having at least one magnet integrated into a surface of the body, and at least one slot formed in the body configured to receive a knife blade. The body may include a flat bottom, two side surfaces, a top and a front surface. With magnetic attraction from each magnet, knives can be securely retained within each knife slot in the body to avoid their accidental disengagement with the body when the body is inadvertently turned over. Further, the body can be conveniently attached to any iron-containing furniture. Additionally, at least one of the sides and the top of the body is substantially flat such that multiple magnetic knife holders can be neatly juxtaposed and/or stacked together and held in such configurations via magnetic attraction.

### RELATED APPLICATION INFORMATION

This application is a Continuation in Part of co-pending U.S. patent application Ser. No. 11/519,001, filed Sep. 12, 2006.

### BACKGROUND

1. Technical Field

The present principles relates to a knife holder, and more particularly, to a magnetic knife holder.

2. Description of Related Art

FIG. 8 shows conventional knife holder 90 according to the know art. Conventional knife holder 90 has a tilt body 91 that is substantially a rectangular solid block having a bottom surface (not numbered), a distal surface (not numbered), a support wedge 93 and multiple knife slots 911. The support wedge 93 is integrally formed on to or as part of the tilt body 91 and has a bottom surface flush with the bottom surface of the tilt body 91. The support wedge supports the tilt body 91 such that it can be placed on a worktop. The knife slots 911 are generally formed in the distal surface of the tilt body 91 in any one of several different configurations for receiving knives 92. In this example, the knife slots 911 are arranged in parallel relationship with each other.

During use, the knife holder 90 is placed on a worktop for convenient use. However, the knife holder 90 does not provide any feature for retaining the knives 92 within the knife slots 911. As a result, when the knife holder 90 is inadvertently knocked over or falls over, the knives 92 fall out of the knife slots 911 thus creating a dangerous condition which could cause potential injury to people. As a result, knife holder 90 does not provide an acceptable level of safety during use.

Knife holder 90 is further limited in that it is limited in its placement on a worktop and thus has a low level of practicality.

### SUMMARY OF THE INVENTION

It is an aspect of the present principles to provide a magnetic knife holder to obviate and mitigate the aforementioned problems of the prior art knife holders.

According to one aspect, the knife holder includes a body having at least one knife slot having a top and a bottom, and at least one magnet integrated into the body adjacent the at least one knife slot. The at least one magnet is disposed near the top of the knife slot such that a knife disposed in the slot is biased upward toward the top of the slot and retained such that a sharp edge of the knife does not contact the bottom of said slot.

According to another aspect, the knife holder includes a body having outer surfaces and at least one knife receiving slot, and at least one magnet integrated into at least one of said outer surfaces of said body. The at least one magnet enabling two or more knife holders to be magnetically connected to each other.

According to a further aspect, the knife holder includes a body having a front surface, side surfaces, top and bottom surfaces and at least one knife receiving slot accessible from said front surface, at first set of magnets integrated into said body adjacent said at least one knife slot, and a second set of magnets integrated into each of said side surfaces of said body. The first set of magnets is disposed near the top of the knife slot such that a knife disposed in the slot is biased upward toward the top of the slot and retained such that a sharp edge of the knife does not contact the bottom of the slot. The second set of magnets enables two or more knife holders to be magnetically connected to each other.

These and other aspects, features and advantages of the present principles will be described or become more apparent from the following detailed description of preferred embodiments, which is to be read in connection with the accompanying drawings.

### BRIEF DESCRIPTION OF THE DRAWINGS

In the drawings wherein like reference numerals denote similar components throughout the views:

FIG. 1 is a perspective view of a magnetic knife holder in accordance with an embodiment of the present principles;

FIG. 2 is a cross sectional front view of the magnetic knife holder in FIG. 1 taken along line II-II;

FIG. 3 is an exemplary operational perspective view of the magnetic knife holder according to another embodiment of the present principles;

FIG. 4 is another exemplary operational perspective view of the magnetic knife holder in FIG. 1 with a knife attached on a surface of the magnetic knife holder;

FIG. 5 is a perspective view of multiple magnetic knife holders connected to each other in a juxtaposed manner, according to one embodiment of the present principles;

FIG. 6 is a perspective view of two magnetic knife holders stacked according to another embodiment of the present principles;

FIG. 7 is a perspective view of multiple knife holders respectively attached in different configurations in a workspace, according to yet a further embodiment of the present principles; and

FIG. 8 is an operational perspective view of a conventional knife holder in accordance with the prior art.

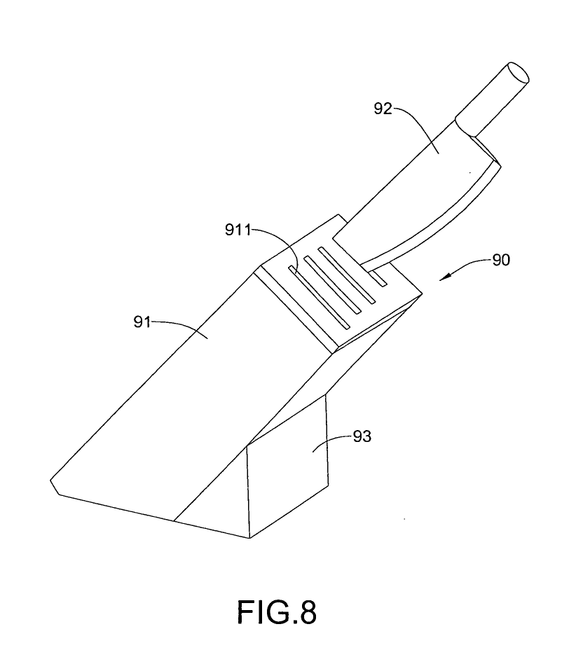

### DETAILED DESCRIPTION OF THE PREFERRED EMBODIMENTS

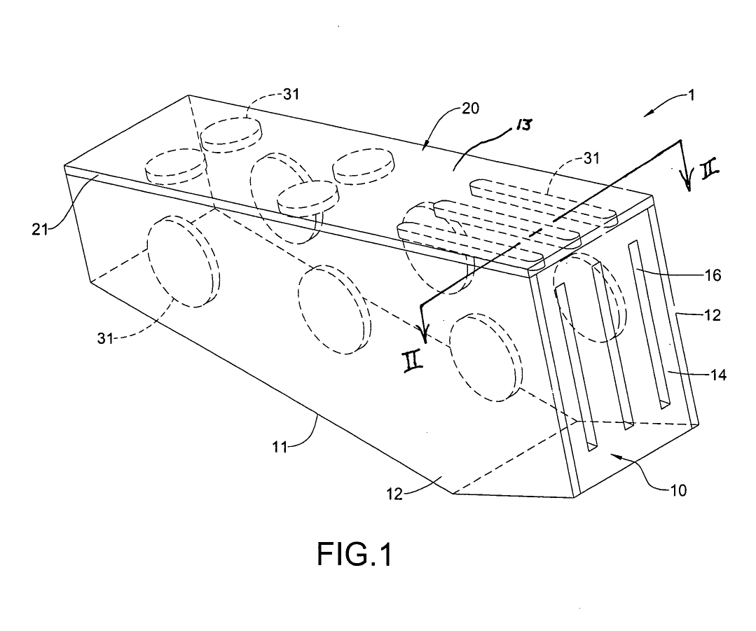

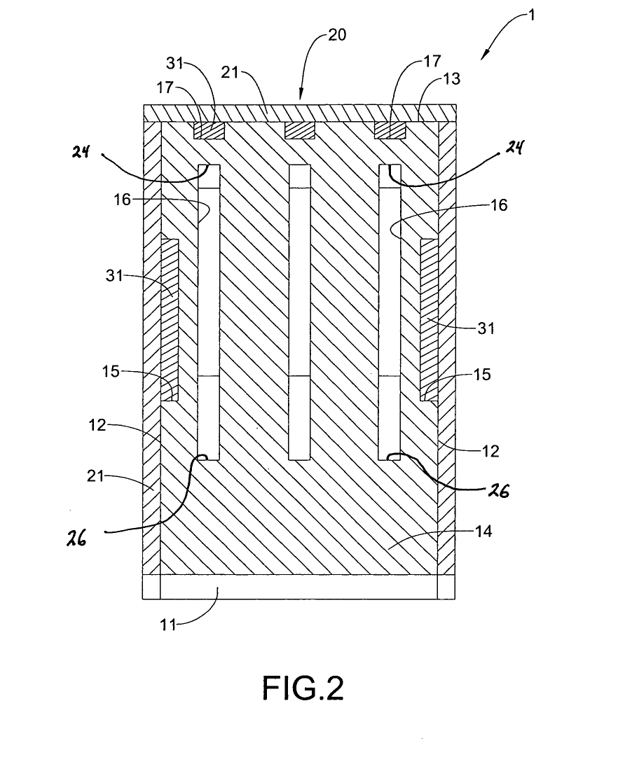

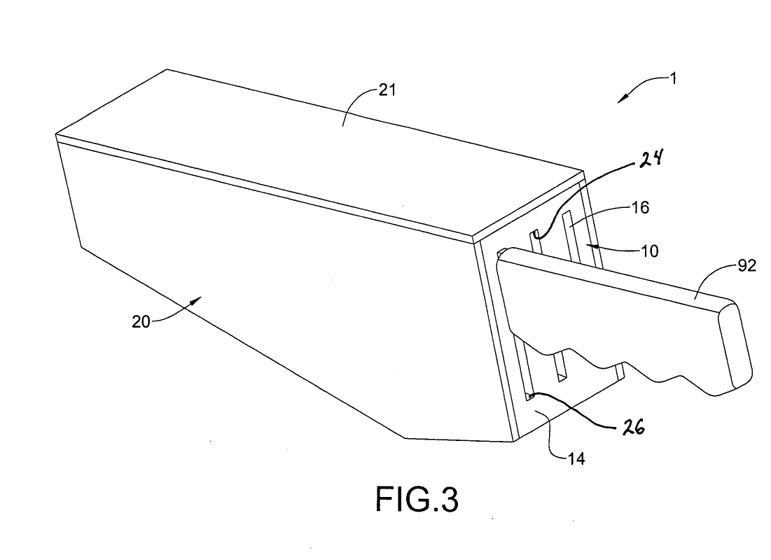

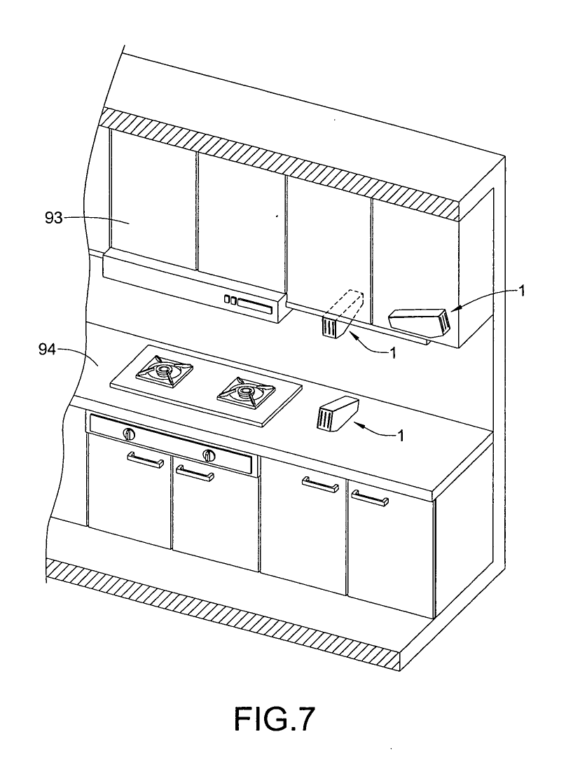

With reference to FIGS. 1 to 7, a knife holder 1 is made up of a body 10 and top cover assembly 20.

According to one embodiment, the body 10 is elongated and has several surfaces. In particular, there is a bottom surface 11 and remaining outer surfaces which include both sides 12 and the top 13. A front surface 14 includes one or more knife slots 16.

In accordance with one aspect of the present principles, the body 10 includes at least one magnet 31 that is integrated into the outer surfaces 12 and/or 13. In alternative embodiments, magnet recess 15, 17 are provided for receiving and securing a magnet 31 therein.

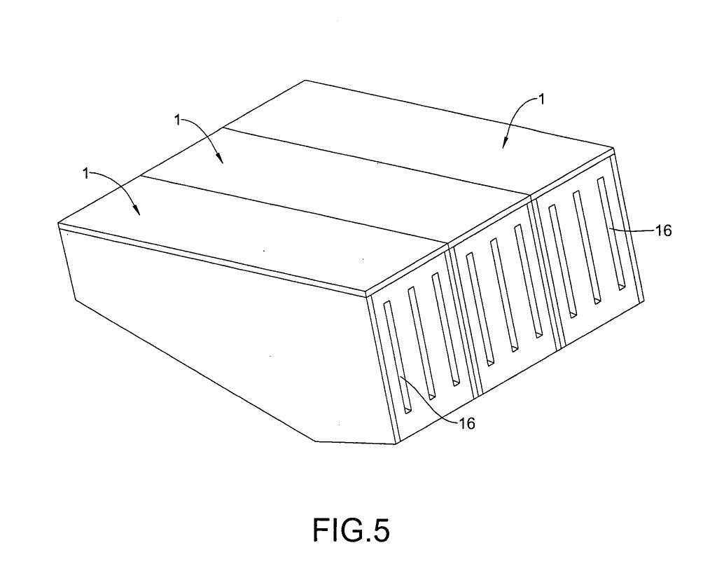

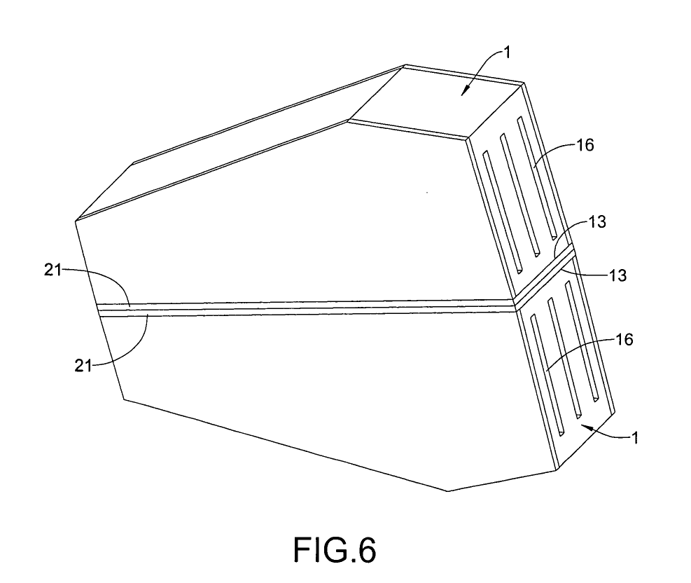

The bottom surface 11 of the body 10 is preferably substantially flat so that the body 10 can be placed on a worktop surface 94. In one preferred configuration, at least one of the sides 12 and the top 13 is substantially flat. Therefore, according to additional embodiments, multiple bodies 10 of magnetic knife holders 1 can be neatly and securely juxtaposed together and/or stacked up, e.g., as shown in FIGS. 5 and 6.

In one exemplary embodiment, the body 10, the sides 12 and the top 13 of the body 10 are all flat.

In another exemplary embodiment, each magnet 31 is integrally formed into the body and positioned just beneath the surfaces of the body 10. As shown, the magnet recesses 15, 17 may be formed respectively in the sides 12 and the top 13 of the body 10.

As shown, the knife slots 16 are formed longitudinally in the front surface 14 of the body 10 for receiving knives 92. The magnets 31 are elongate magnets and are disposed longitudinally along the top 13 of the body 10 and are preferably aligned parallel to each other, and disposed above the top 24 of each knife slot 16. According to the various embodiments disclosed, magnets 31 can be integrated into the top surface 13 of the body 10 using recesses 17 or any other known method for enclosing magnets 31 in body 1.

According to one preferred embodiment, the number of elongate magnets 31 and corresponding elongate magnet recesses 17 (in those alternative embodiments) is equal to the number of knife slots 16. In this manner, knives 92 can be securely received and retained within the knife slots 16 via magnetic attraction, such that even if the body 10 is inadvertently turned over or knocked over, the knives 92 do not spill out but are still held securely within the knife slots 16. Thus, not only does this ensure the safety of the knife holder during use, but is also operates to keep the sharp edge of the knife from contacting the bottom 26 of the knife slot during use of the magnetic knife holder 1. This concept of placing a magnet at the top of knife slot is generally applicable to vertical knife slots. However, it is herein contemplated that horizontal or any angularly disposed knife slot can also benefit from the concepts of the present principles. By way of example, with horizontal and or angularly disposed knife slots in a knife holder, the use of elongate magnets 31 disposed at one end of the slot can operate to keep the sharp edge of a knife from contacting the opposing internal side of the same slot.

In one exemplary embodiment, each magnet 31 respectively corresponds to and is mounted within the magnet recesses 15, 17 in the surface of the body 10. Alternatively, each magnet 31 may be integrated/integrally formed with the body 10 via other means such as attachment via adhesives, injection molding, etc. Therefore, the body 10 having magnets included therein can be conveniently attached to a bottom or a front of a hanging cabinet 93 or other iron-containing furniture via magnetic attraction to increase practicability and versatility in placement of the magnetic knife holder 1.

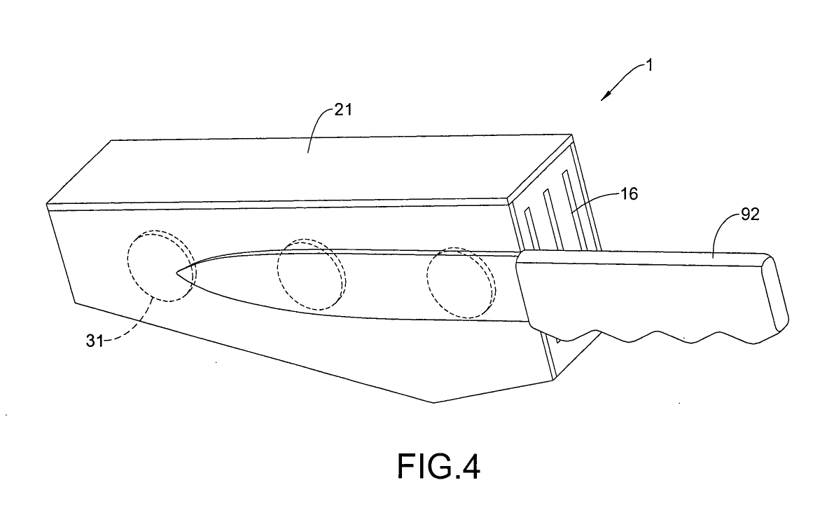

As is shown with further reference to FIG. 4, by integrating magnets into the outer surfaces of the body 10 (i.e., sides 12) of the knife holder 1, a user, (e.g., during cooking) can temporarily attach his/her knife 92 to the outer surface of the body 10 (i.e., side surface 12) by magnetic attraction instead of placing the knife on the worktop 94. Thus, the knife 92 does not become contaminated by dirt on the worktop 94 and vice versa.

According to another exemplary embodiment, the body 1 can have a removable cover assembly 20 to enable replacement of and/or access to the magnets 31. The cover assembly/panels 20 may be mounted on the body 10 to cover the magnets 31 in the magnet recesses 15, 17 to keep the body 10 neat. The cover assembly/panels 20 respectively correspond to the outer surfaces designated by the side surfaces 12 and the top surface 13.

The magnetic knife holder 1 has following advantages:

1. Safety In Use: Knives 92 can be securely received and retained within the knife slots 16 in the body 10, such that even if the body 10 is inadvertently turned over, the knives 92 are still hold securely in the knife slots 16 by magnetic attraction to protect people from being injured by falling knives 92.

2. Sanitation: During cooking, a cook can temporarily put his/her knife 12 on the surface of the body 10 to avoid, e.g., contamination with dirt on the worktop 94.

3. Higher practicability: the magnetic knife holder 1 can be conveniently attached to any iron-containing furniture. Accordingly, the magnetic knife holder 1 can be mounted so as to not occupy any area on the worktop 94, thus increasing its convenience and practicality.

4. Increased Knife edge life: Through the placement of the magents 31 adjacent the top 24 of the knife slots 16, the knives 92 are magnetically biased up toward the top 24 of the knife slot 16 and retained there such that the sharp edge of the knife does not contact the bottom 26 of the knife slot. This is contrary to current knife holders where the knife slides in and out of knife slots and the sharp edges contact the internal surfaces of the slot.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A knife holder comprising:
a body having at least one knife slot having a top and a bottom; and
at least one magnet integrated into said body adjacent said at least one knife slot, said at least one magnet disposed near the top of said slot such that a knife disposed in said slot is biased upward toward the top of said slot and retained such that a sharp edge of the knife does not contact the bottom of said slot.

2. The knife holder of claim 1, wherein said body further comprises side surfaces and top and bottom surfaces.

3. The knife holder of claim 2, further comprising at least one additional magnet integrated into said body adjacent at least one of said side surfaces.

4. The knife holder of claim 4, wherein said at least one additional magnet enables two or more knife holders to be magnetically connected to each other by abutting the respective side surfaces against each other.

5. The knife holder of claim 2, wherein said at least one magnet is integrated into said body such that it is also disposed adjacent said top surface, wherein said at least one magnet also enables two or more knife holders to be magnetically connected to each other by abutting respective top surfaces against each other.

6. The knife holder of claim 1, further comprising at least one magnet recess for receiving and retaining said at least one magnet in a fixed position integrated within said body.

7. The knife holder of claim 4, further comprising at least one additional magnet recess for receiving and retaining said at least one additional magnet in a fixed position integrated within said body.

8. The knife holder of claim 1, wherein said at least one magnet comprises an elongated magnet aligned with each of said at least one knife slot.

9. A knife holder comprising:
a body having outer surfaces and at least one knife receiving slot; and
at least one magnet integrated into at lease one of said outer surfaces of said body, said at least one magnet enabling two or more knife holders to be magnetically connected to each other.

10. The knife holder of claim 9, wherein said at least one magnet further enables a knife to be magnetically secured to the at lease one outer surface.

11. The knife holder of claim 9, further comprising at least one additional magnet integrated into said top surface of said body.

12. The knife holder of claim 9, wherein said outer surfaces comprise two side surfaces and a top surface.

13. The knife holder of claim 9, wherein said outer surfaces comprise two side surfaces and a top surface, and wherein said at least one knife slot further comprises a top and a bottom.

14. The knife holder of claim 13, further comprising at least one additional magnet integrated into said top surface of said body and positioned adjacent said top of said knife slot.

15. The knife holder of claim 14, wherein said at least one additional magnet comprises an elongated magnet longitudinally aligned with each of said at least one knife slot.

16. A knife holder comprising:
a body having a front surface, side surfaces, top and bottom surfaces and at least one knife receiving slot accessible from said front surface;
at first set of magnets integrated into said body adjacent said at least one knife slot, said first set of magnets being disposed near the top of said slot such that a knife disposed in said slot is biased upward toward the top of said slot and retained such that a sharp edge of the knife does not contact the bottom of said slot; and
a second set of magnets integrated into each of said side surfaces of said body, said second set of magnets enabling two or more knife holders to be magnetically connected to each other.

17. The knife holder of claim 16, further comprising a third set of magnets integrated into said top surface of said body, said third set of magnets enabling two or more knife holders to be magnetically connected to each other.
